(19) United States
(12) Patent Application Publication
(10) Pub. No.: US 2003/0178960 A1
(43) Pub. Date: Sep. 25, 2003

(54) Apparatus and method for controlling self-contained power generation and power utilization system

(76) Inventor: David M. Kassing, Stafford, TX (US)

Correspondence Address: Albert B. Deaver, Jr., 750 Bering Drive, Houston, TX, 77057-2198, US

(21) Appl. No.: 10/103,006

(22) Filed: Mar. 21, 2002

(51) Int. Cl. H02P 1/04

(52) U.S. Cl. 318/430

(57) ABSTRACT

A system and method is disclosed for drilling a borehole using a silicon controlled rectifier (SCR) system. The SCR system includes analog rack mounted hardware cards for control of an engine AC generator and a DC load. The engine AC generator of the SCR system generates alternating current (AC) that is then converted to direct current (DC) by a silicon controlled rectifier transformer connected to the output of the engine AC generator. The DC power from the silicon controlled rectifier transformer drives one or more DC motors that are coupled to a load by a mechanical linkage. An AC generator controller controls the engine AC generator and includes an engine control module that controls operating speed of the engine AC generator and air-fuel mixture at engine start. A DC load controller coupled to the silicon controlled rectifier transformer and DC motors performs automatic load share control between the DC motors.

### BACKGROUND OF THE INVENTION

1. Field of the Invention

This invention relates generally to a control system for a self-contained power generation and prime mover system, and, more particularly, this invention is directed to a system and method of controlling an AC power generator and DC power prime movers, such as those found on a conventional oil well drilling rig.

2. Background of the Related Art

Both land-based and sea-based oil well drilling rigs require a complex system of electrical power generation and utilization, and control systems for both. For example, a conventional oil well drilling rig may comprise one or more diesel powered alternating current (AC) generators, one or more silicon controlled rectifiers (SCRs) to transform the AC power to direct current (DC) power, one or more DC motors for accomplishing the needed work, such as drilling and pumping, and an interlinked control system to control the diesel engines, the AC generators, the SCRs and the DC motors.

Prior art control systems were subject to environmental degradation in the harsh oil field environments, which degradation often times resulted in voltage and current supply fluctuations and difficult repairs. Advances in computer hardware and software have found their way into controlling these drilling rig systems. State-of-the-art drilling rigs may now include a so-called “Star Wars” chair from which an operator can monitor and control the various drilling rig functions. However, the simplicity and convenience of these software-based control systems is offset by the complexity of the software and the inconvenience of software “crashes.” When such crashes occur, it is imperative that the systems be brought back online in as short a time period as possible. Often times, the drilling rig personnel are not schooled in the detailed troubleshooting and repair of these complex software systems and, therefore, a technician or other support personnel must be physically or electronically delivered to the drilling rig.

The present invention is directed to a hardwired control system of modular design having a minimum of components such that typical drilling rig personnel can replace discrete control system modules to bring the system back online in a short period of time.

### SUMMARY OF THE INVENTION

One of the many embodiments of the present invention includes a silicon controlled rectifier (SCR) system having analog rack mounted hardware cards for control of an engine AC generator and a DC load. The engine AC generator of the SCR system generates alternating current (AC) that is then converted to direct current (DC) by a silicon controlled rectifier transformer connected to the output of the engine AC generator. The DC power from the silicon controlled rectifier transformer drives one or more shunt wound DC motors that are coupled to a load by a mechanical linkage such as a drive shaft. The load may be a mud pump or drilling mechanism. An AC generator controller controls the engine AC generator and includes an engine control module that controls operating speed of the engine AC generator and air-fuel mixture at engine start. A DC load controller controls the silicon controlled rectifier transformer and DC motors. A drill operator at an operator console coupled to the AC generator controller and DC load controller provides input and receives output from the SCR drive system.

The DC load controller performs automatic load share control between the DC motors and includes isolator hardware that receives a first signal and a second signal and filters these signals to reduce noise and carriers. The filtered signals are output to load share hardware that determines the error difference between the two signals. Feedback hardware coupled to the load share hardware modifies a power output of one motor based on the error.

### BRIEF DESCRIPTION OF THE DRAWINGS

FIG. 1 shows a block diagram of a control system in accordance with a preferred embodiment of the invention;

FIG. 2 shows a physical design of a card rack with multiple bays, a set of bay connections, and cards in slots of the bays in accordance with a preferred embodiment of the invention;

FIG. 3 shows a physical design of one bay of a card rack for an SCR Controller in accordance with a preferred embodiment of the invention;

FIG. 4 shows a schematic diagram of a throttle/summing and current limit regulator card in accordance with a preferred embodiment of the invention;

FIG. 5 shows a schematic diagram of the interconnection between a driller's console, SCR system regulator card, high voltage feedback card, and load share card in a card rack bay in accordance with a preferred embodiment of the invention;

FIG. 6 shows a schematic diagram of a SCR system regulator card in accordance with a preferred embodiment of the invention;

FIG. 7 shows a schematic diagram of a high voltage feedback card in accordance with a preferred embodiment of the invention;

FIG. 8 shows a schematic diagram of a load-sharing card in accordance with a preferred embodiment of the invention;

FIGS. 9a-9b shows two cards that together implement the functionality of the load-sharing card and are an alternative embodiment of the load sharing card;

FIG. 10 shows a schematic diagram of a fan loss card in accordance with a preferred embodiment of the invention;

FIG. 11 shows a schematic diagram of a top drive interface card in accordance with a preferred embodiment of the invention;

FIG. 12 shows a schematic diagram of a current isolator card in accordance with a preferred embodiment of the invention;

FIG. 13 shows a schematic diagram of an engine controller card in accordance with a preferred embodiment of the invention;

FIG. 14 shows application of an LM317T for adjustable voltage regulation;

FIG. 15 shows a schematic diagram of an amplifier card in accordance with a preferred embodiment of the invention;

FIG. 16 shows a schematic diagram of a voltage regulator card in accordance with a preferred embodiment of the invention;

FIG. 17 shows a schematic diagram of a power supply card located in the card rack that supplies power to all other cards in accordance with a preferred embodiment of the invention;

FIG. 18 shows a schematic diagram of a panel voltmeter display card in accordance with a preferred embodiment of the invention; and

FIG. 19 shows a schematic diagram of an AC generator exciter power card in accordance with a preferred embodiment of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct electrical connection, or through an indirect electrical connection via other devices and connections.

### DESCRIPTION OF THE PREFERRED EMBODIMENTS

To help illustrate and communicate the present invention, a presently preferred embodiment of the present invention for use on a conventional oil well drilling rig will be described. The present invention has broader application than the preferred embodiment disclosed herein and the following description is meant to illuminate the broad invention rather than limit or confine the invention.

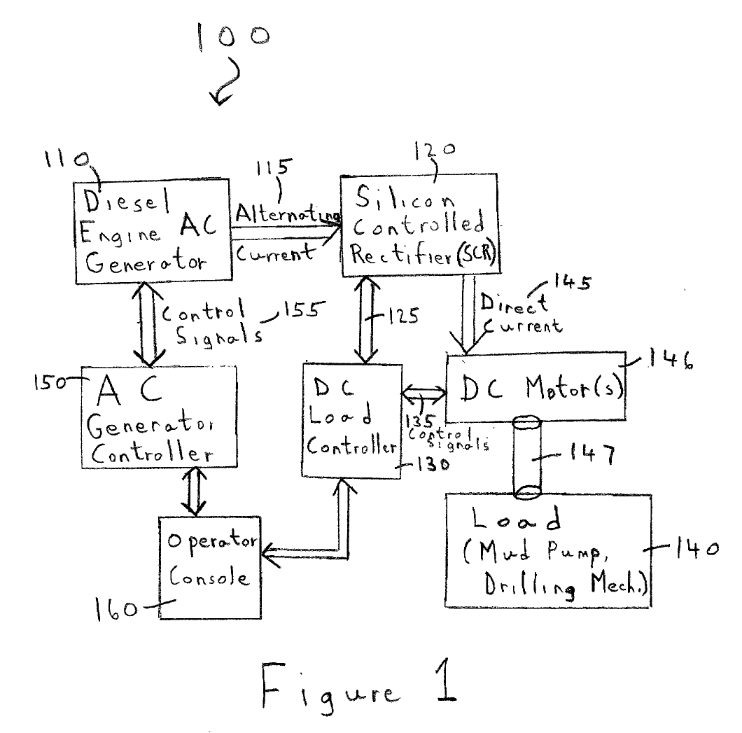

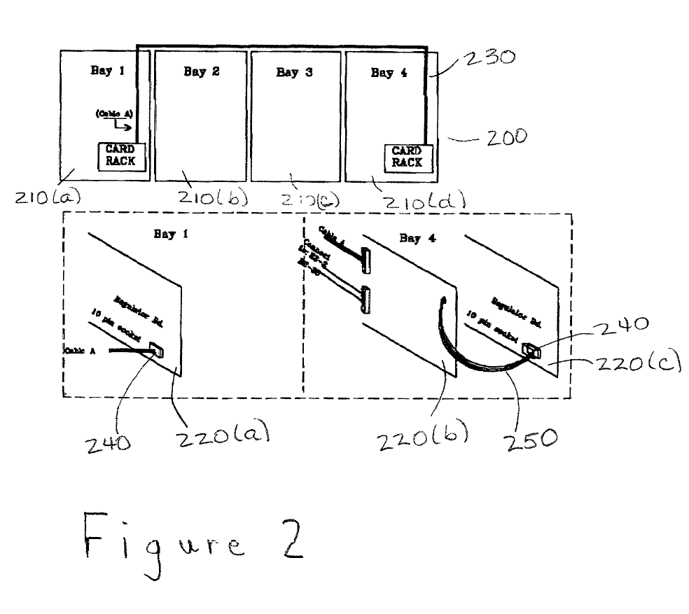

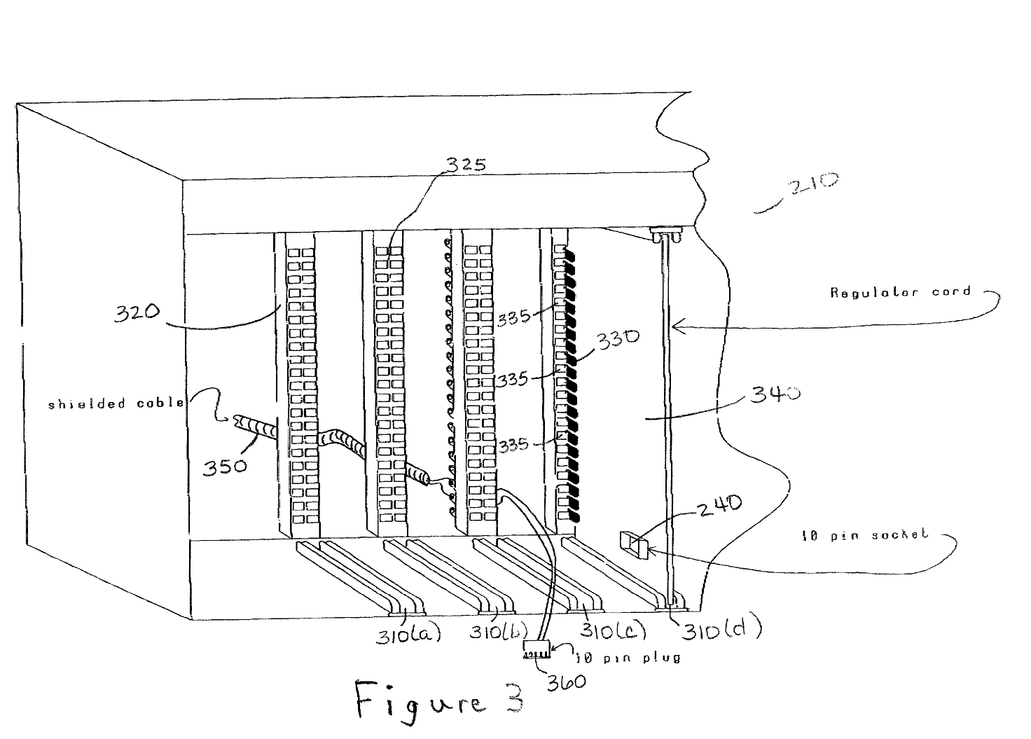

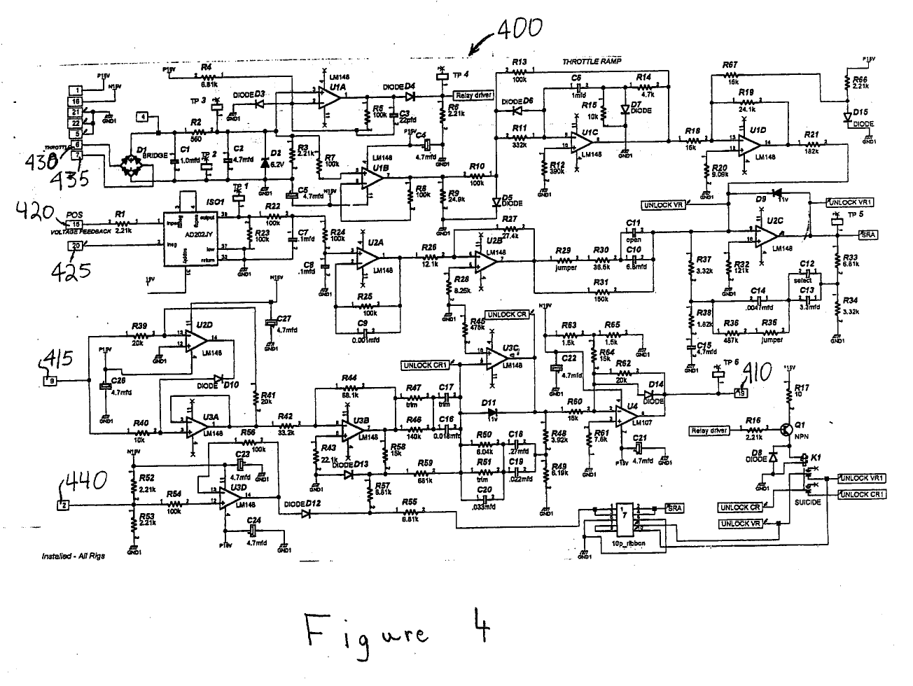

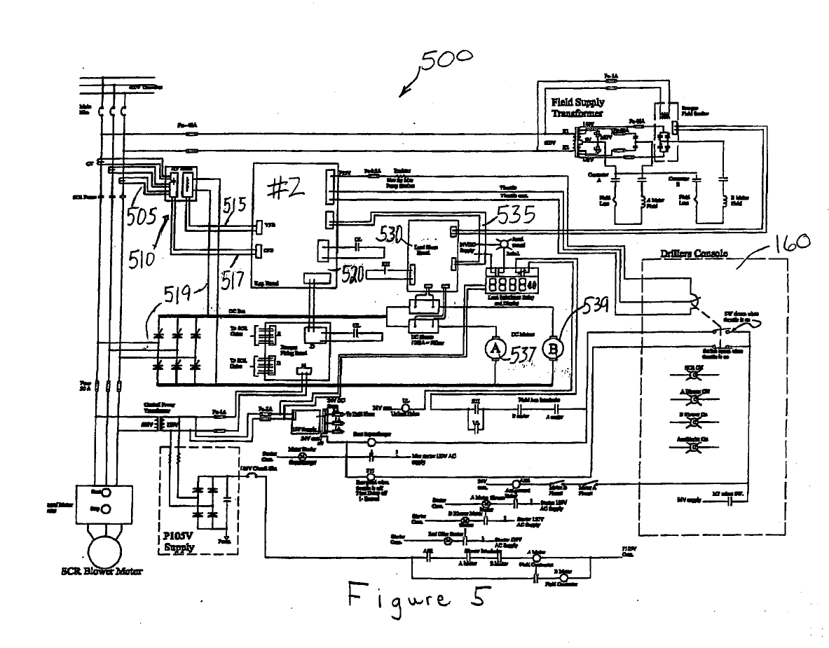

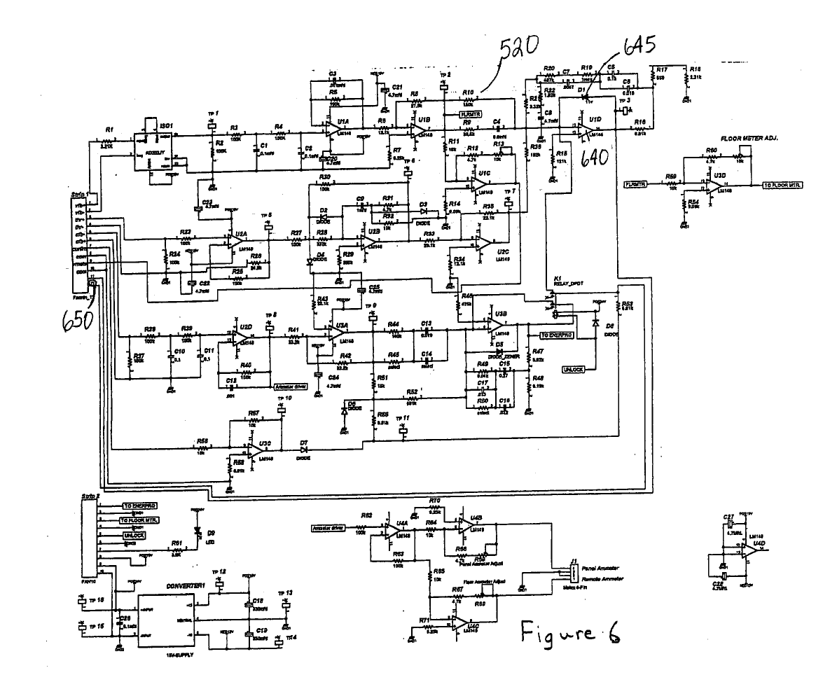

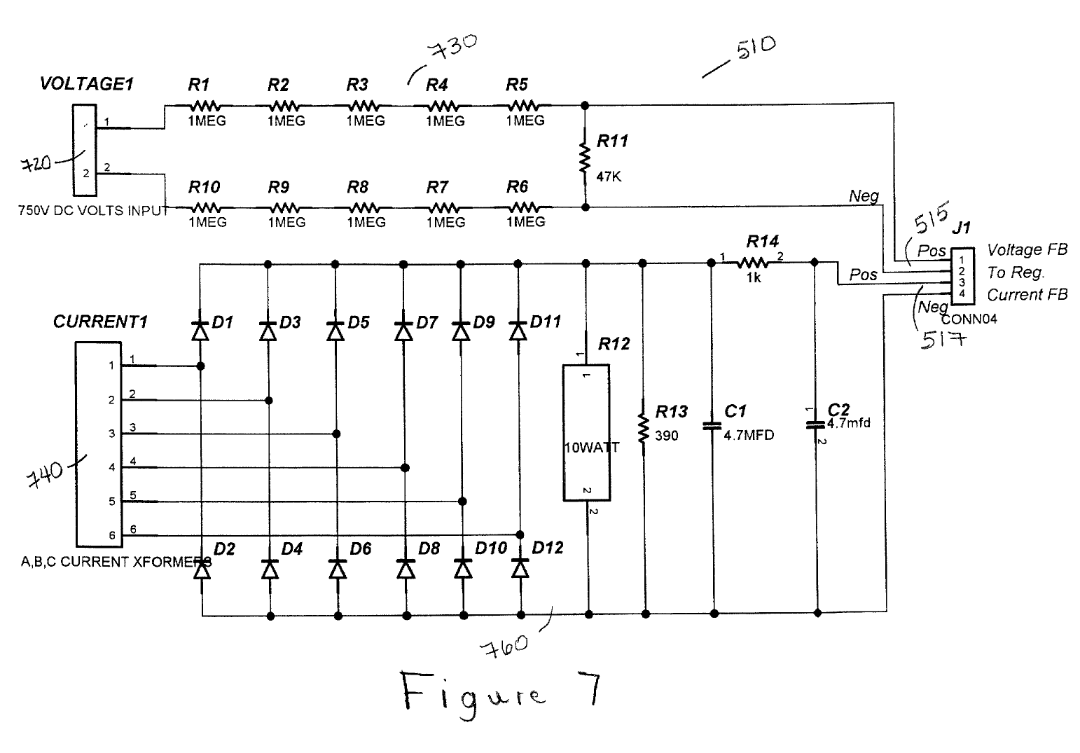

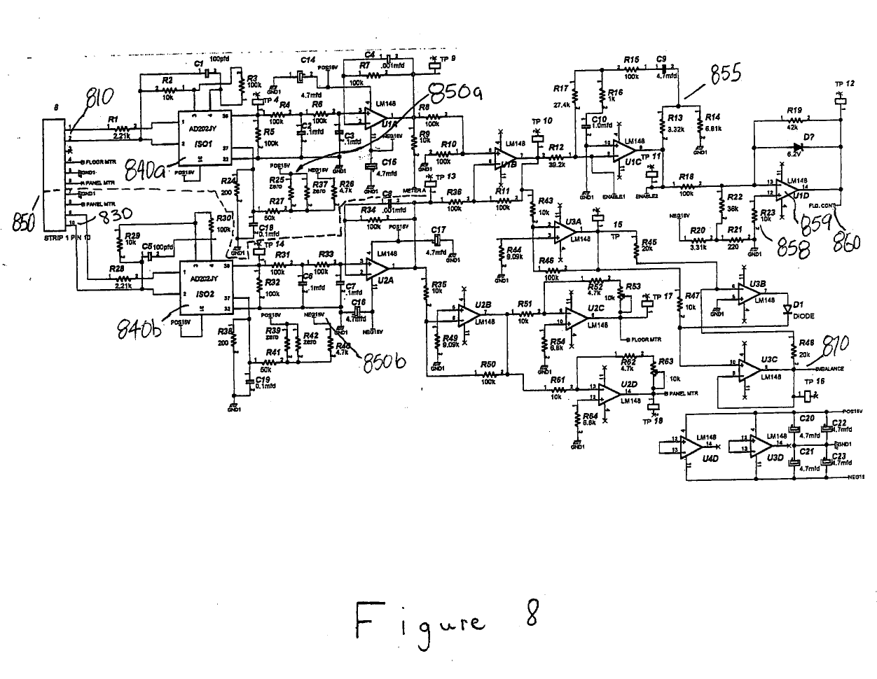

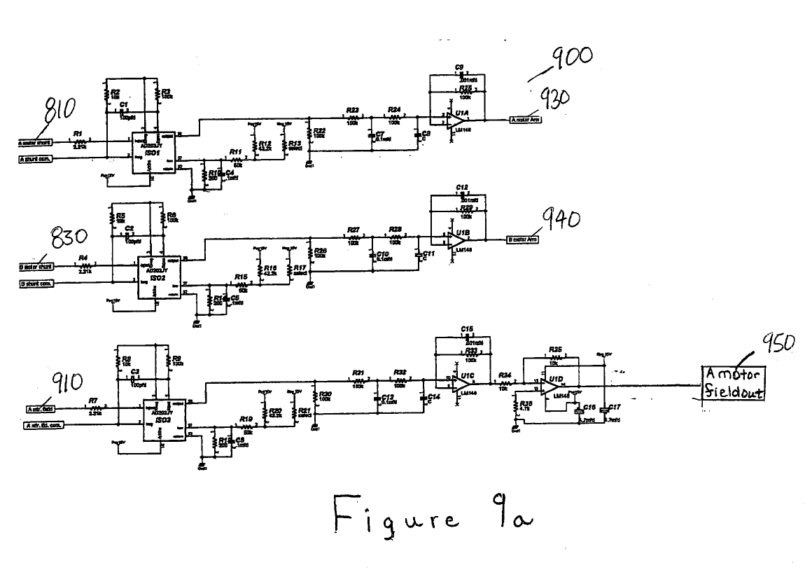

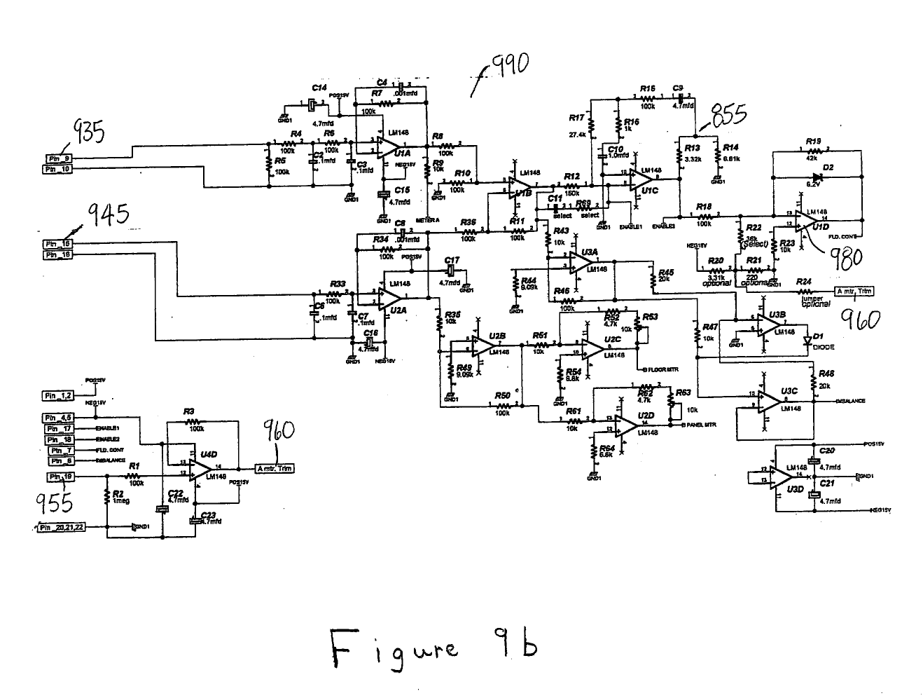

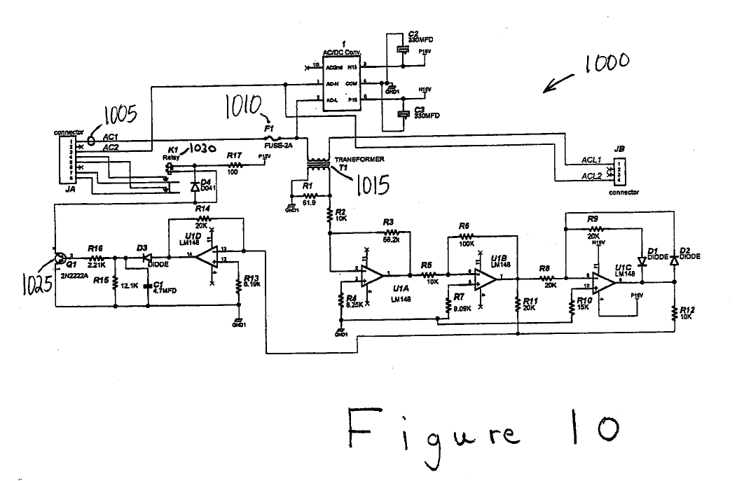

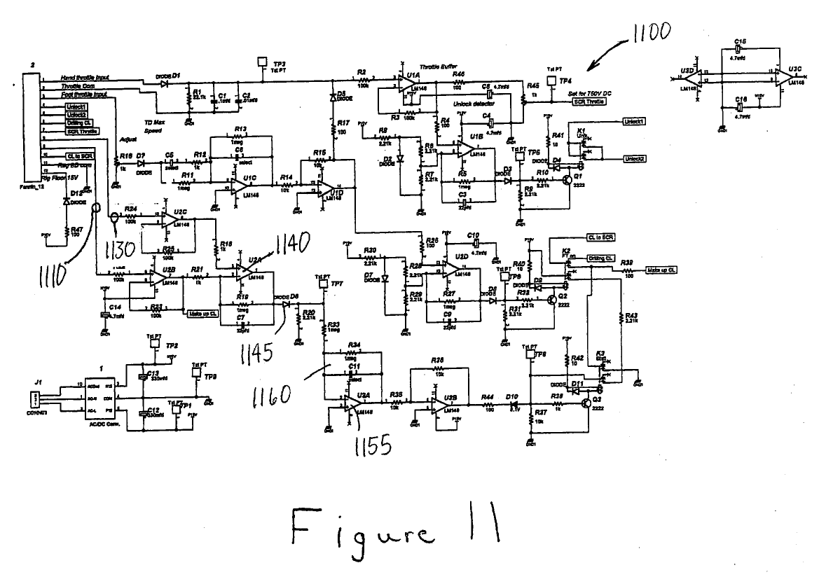

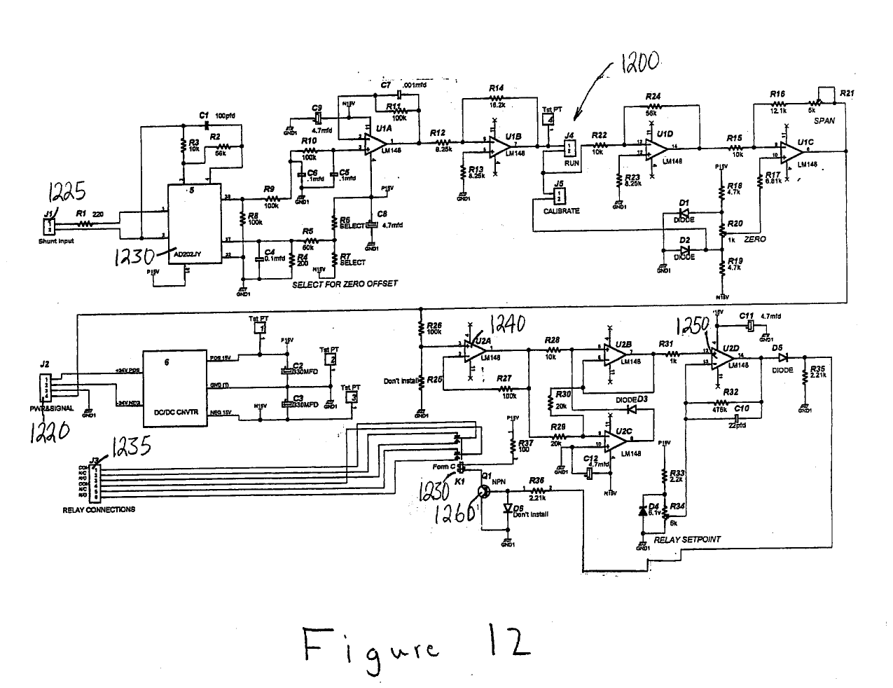

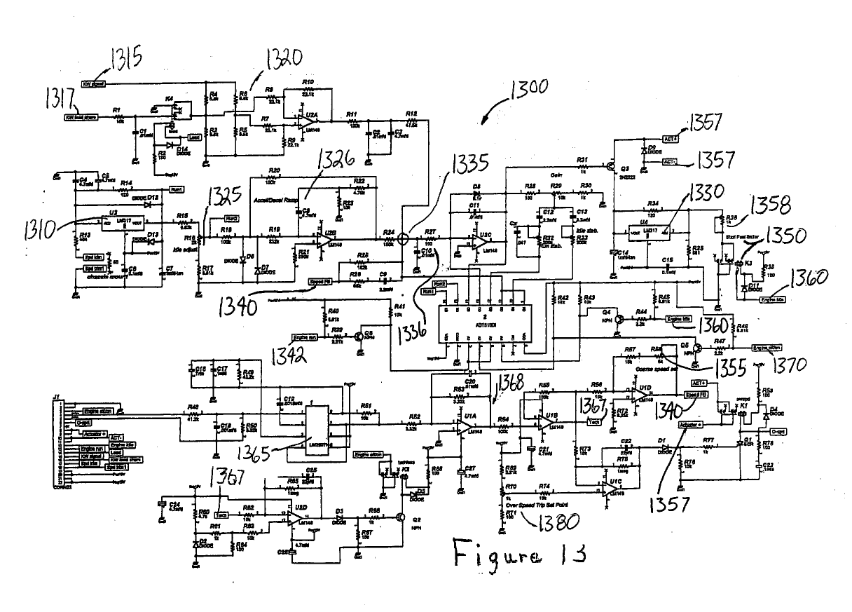

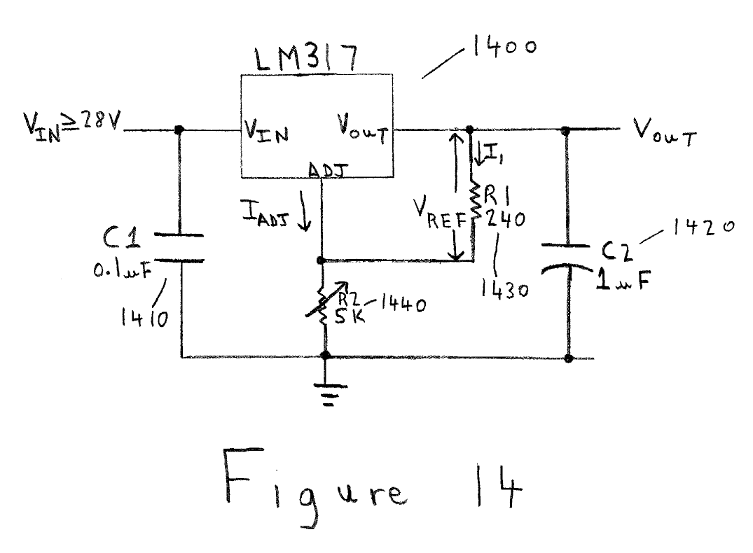

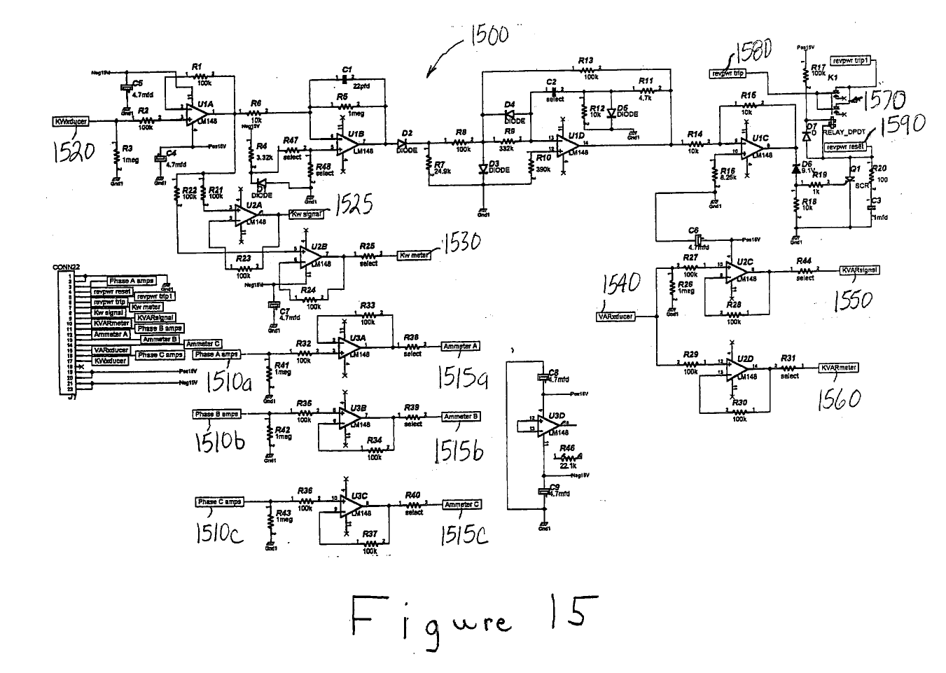

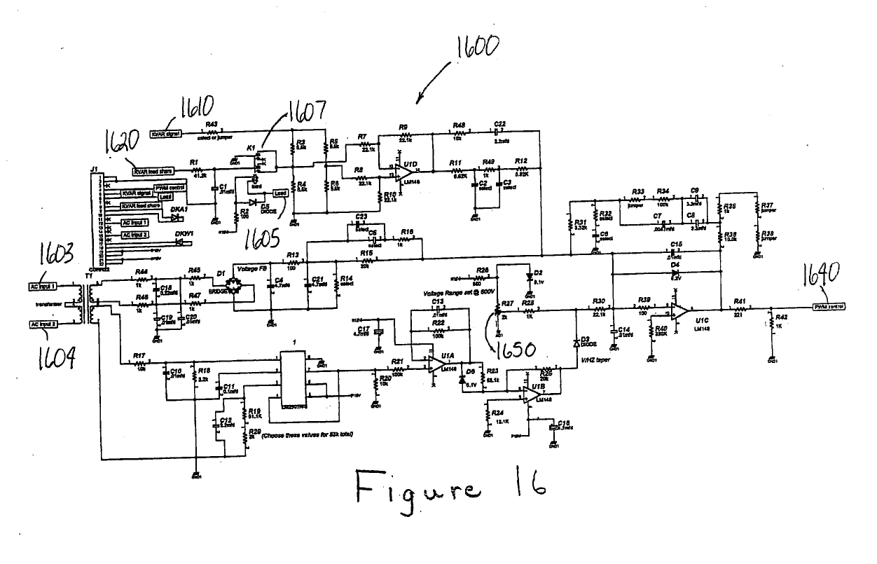

Referring now to FIG. 1, in accordance with a preferred embodiment of the invention, a silicon controlled rectifier 100 for oilfield drilling comprises a hydrocarbon engine powered Alternating Current (“AC”) generator 110. In one preferred embodiment, the hydrocarbon engine AC generator 110 may be a diesel engine AC generator. In other embodiments the engine AC generator may burn gasoline, methane, natural gas, or liquefied natural gas (“LNG”). The diesel engine AC generator 110 of the preferred embodiment shown in FIG. 1 produces alternating current 115 that is output to a silicon controlled rectifier (“SCR”) 120. The SCR 120 converts the alternating current into direct current 145 (“DC”) which the SCR then scales and outputs to one or more DC motors 146. The DC motor(s) 146 couple to a load 140 preferably through a mechanical linkage 147 such as a drive shaft. The DC motors 146 may be shunt-wound electric motors such as that used as a drill motor or drawworks motor on a drilling rig. Preferably, the DC load 140 may be a mud pump or drilling mechanism such as a drill stem and drill bit. In the preferred embodiment, the DC load controller couples to the DC motor(s) through communication bus 135 and transmits/receives control signals from the DC motor(s) 140. The DC load controller 130 also transmits/receives control signals to the silicon controlled rectifier 120 through communication bus 125. Preferably, an operator console 160 couples to both the DC load controller 130 and AC generator controller 150. The operator console includes various meters, LEDs, switches and other equipment that display output signals and allow operator input to the AC generator controller and DC load controller.

In the preferred embodiment of the invention shown in FIG. 1, the AC generator controller 150 may be a card rack including a number of bays electrically coupled to each other through backplane physical connections. Each bay includes a number of card slots that each hold a slidable card. The cards perform various control, data collection and power functions in the silicon controlled system for oilfield drilling. Unlike prior art systems that use hardware digital integrated circuits and complex software systems, each card is implemented using simple analog circuitry for reduced component count design. Analog design lowers costs and drilling rig down time by allowing drilling rig operators to replace cards that are worn out or defective in the field without having to call an expensive technician or engineer to remedy the problem. Each of the cards in the AC generator controller 150 is described in greater detail below.

Similarly, the preferred embodiment of the invention shown in FIG. 1 includes a DC load controller 130 that preferably may be implemented by a card rack containing a number of bays with each bay including a number of card slots. In one preferred embodiment the cards may be implemented using analog circuitry.

Turning now to FIG. 2, as described above the AC generator controller 150 of the preferred embodiment may be implemented using a card rack system 200 containing multiple bays 210(a)-210(d). Each bay may include a number of card slots each containing a slidable analog hardware card 220(a)-220(c). In an alternative embodiment, rather than the use of hardware cards that slide into card slots, each hardware card 220(a)-220(c) may be bolted into the card rack using fasteners such as screws or bolts. The cards may be connected through the back plane of the card rack as shown for connection 230 coupling the load sharing signal of bay 1 and bay 4. In an alternative embodiment, a shielded cable may be used to carry the load sharing signal between bay 1 and bay 4. Cards may also be coupled to each other through a cable 250 connecting physical sockets such as 10 pin socket 240 shown on regulator board 220(a) and 220(c).

Turning now to FIG. 3, in the preferred embodiment of the invention, each bay 210 of the card rack may preferably include four card slots 310(a)-310(d) (as shown) or five card slots that each accept a slideable card 340. Preferably, each slideable card would connect to backplane 320 through backplane coupler 325. As shown in FIG. 3 for regulator card 340, each card contains metal insert tabs 330 that form an electrical connection with the teeth 335 of the backplane coupler 325. The physical connection between metal insert tabs 330 and teeth 335 combined with the slideable nature of each card in card slot 310 allow easy removal and insertion of cards. This permits a rig operator to easily repair or replace a defective card. FIG. 3 also shows one embodiment for connecting cards together in a bus using a shielded cable 350 coupled to a 10 pin plug 360 through the backplane 320. In this embodiment of the invention, the 10 pin plug 360 couples to card 340 through a 10 pin socket 240.

FIG. 4 in accordance with one embodiment of the invention shows a schematic diagram of a throttle/summing and current limit regulator card 400. Preferably, this card implements a closed loop feedback control system that feeds the output throttle/summing and current limit signals back into the inputs of the card to maintain the stability of the signals. Prior art systems implement open loop control of the throttle/summing and current limit signals leading to fluctuation and instability of these signals. In the preferred embodiment of the invention, output pin 19 410 generates control signals to SCR firing boards. Current signals are input to the regulator card 400 from an external sample point at input signal lines 9 415. Voltage signals are input to the regulator card 400 from external sample points at input signal lines 15 420 and 20 425. The input signal lines 9 415, 15 420, and 20 425 are compared with operator generated throttle request inputs at signal lines 6 430 and 7 435 to create the control signal at output pin 19 410. The feedback path described above maintains the stability of the closed loop feedback system of current limit regulator card 400. Preferably, input signal line 2 440 receives a current limit threshold signal from a setpoint potentiometer that is compared against the external sample point current signal at line 9 415 with the output of the comparison helping generate output signal 19 410. In the preferred embodiment of the invention, the feedback control circuitry shown in FIG. 4 causes a steady ramp up and ramp down of the output throttle/summing and current limit signals even if the input signals are unstable and widely fluctuating.

Turning now to FIG. 5, in the preferred embodiment of the invention, a schematic diagram 500 of the interconnection between a high voltage feedback card 510, SCR system regulator card 520, load share card 530, and driller's console 550 in different slots of a card rack bay is shown. The high voltage feedback card 510 receives as input SCR control signals 505 and outputs voltage feedback (“VFB”) 515 and current feedback (“CFB”) 517 signals to the SCR system regulator card 520. Preferably, through part of feedback path 519 of the high voltage feedback card 510, the VFB and CFB signals couple to control circuitry that performs voltage and current isolation and scaling of these signals. SCR system regulator card 520 couples to load share card 530 preferably through DC output power lines 535. Load share card 530 couples to DC Motor A 537 and DC Motor B 539 and provides automatic load share control between the two motors that each power one of the dual mud pumps implemented in the preferred embodiment of the invention shown in FIG. 5. A driller's console 160 couples to the SCR system regulator card 520 and permits the driller to turn the SCR on/off. The driller's console 160 also includes various dials, CRT display monitors and other equipment that allows operator input to the silicon controlled rectifier system.

In accordance with a preferred embodiment of the invention, FIG. 6 shows a more detailed schematic diagram of the SCR system regulator card 520. In the preferred embodiment, the SCR system regulator card implements a closed loop feedback control system similar to the throttle/summing and current limit regulator card of FIG. 4. In the SCR system regulator card 520, the feedback control system processes operator throttle requests, compares the throttle requests against a current limit set point and external sample point voltage signals and outputs the resultant signal from line 12 650. This output signal because of the feedback is stable and highly controlled. The output signal from line 12 650 is sent to SCR firing boards. One feature of the circuitry used in the preferred embodiment of the invention is the use of operational amplifier 640 coupled in parallel to diode 645 to create a hysterisis free current limit clamp that has no current overshoot. Thus, the output current does not overshoot and so the DC motor remains stable and does not rock. The circuit functions without hysterisis because the voltage is clamped at the value of the voltage drop across the diode 645, i.e. the diode is forward biased at a voltage value at which point the voltage is clamped. Operational amplifier 640 is used to “sink” any excess current, i.e. the excess current is actually drawn into the operational amplifier circuit.

Turning now to FIG. 7, a more detailed schematic diagram of the high voltage feedback card 510 is shown in accordance with the preferred embodiment of the invention. Preferably, the card receives as input voltage and current signals that are then isolated and scaled prior to being output to the SCR system regulator card 520. Voltage across terminal 720 is driven through the resistive network 730 and the scaled value output through VFB terminal 515. The high voltage feedback card 510 also receives 8 current at input terminal 740 that is then driven across the parallel diode, resistive, capacitive network 760 and the scaled and isolated current value output through CFB terminal 517.

FIG. 8 shows a more detailed schematic diagram of the load sharing card 530 in accordance with the preferred embodiment of the invention. Preferably, the load sharing card permits DC loads to be automatically shared between multiple DC motors. Automatic load sharing prolongs the life of each of the DC motors by equalizing the load placed on each motor so that the motors are not operated at their limits. In the preferred embodiment, the load sharing card 530 provides automatic load sharing between DC motor A 537 and DC motor B 539 that connect through a common shaft to a mud pump or other drilling mechanism. Preferably, DC motor A and B are shunt wound DC motors but in alternative embodiments series wound DC motors or compound wound DC motors may be used. In FIG. 8 two identical circuits are shown separated by dashed line 805. These two closed loop feedback circuits preferably compare the power output signals 810 and 830 of each of the DC motors after isolating the signals in isolators 840a and 840b, take the error (i.e. subtract the power output signals) and through the field control signal 860 adjusts the power input of one of the motors (thus modifying the power output of the motor) based on the error. In the preferred embodiment, isolator 840a and 840b are Analog Devices AD202JY but any two port isolator circuit with similar functionality may be used. Immediately following each isolator 840a and 840b are filter circuits 850a and 850b that operate at 20 KHz frequency and are used to remove any noise or carrier signals. After isolation and filtering the two signals are sent to integrator circuit 855 which determines the error between the two signals. Preferably, an imbalance signal 870 is output to an external display that indicates to an operator the difference in output amps between the two DC motors. Use of closed loop feedback load sharing circuits as shown in FIG. 8 unlike prior art open loop load sharing circuits do not require the manual calibration of isolator cards or manually setting the value of the field control signal on one or more of the motors.

Turning now to FIGS. 9a-9b, an alternative embodiment of the load sharing card of FIG. 8 is shown. The two cards shown in FIGS. 9a and 9b together implement the functionality of the load sharing card of FIG. 9 described above. Like the load sharing card shown in FIG. 8, A motor shunt 810 and B motor shunt 830 on the isolator card 900 receive power or current output signals from DC motor A and DC motor B respectively. Preferably, in addition to these two inputs, an additional input A motor field 910 tracks the value of the shunt field current in DC motor A. In the load sharing card implementation shown in FIG. 8, a setpoint for DC motor B field current is fixed by resistors R20, R21, and R22 into the negative terminal of operational amplifier 859. This setpoint value is the minimum allowable DC motor B field current and is intentionally fixed low. The motor load imbalance error signal at 855 described above is input to amplifier 859 and is algebraically added to the setpoint value at the negative terminal of amplifier 859. The error signal at 855 must be relatively large before the load share card shown in FIG. 8 begins automatic load share control. In the alternative implementation of the cards shown in FIGS. 9a-9b, because the A motor field out signal 950 is fed back to the load share card section in FIG. 9b and into the setpoint circuit, this eliminates the delay in the start of automatic load share control. The alternative implementation shown in FIGS. 9a-9b causes DC motor A field current to closely track the B motor field current setpoint. Thus, in this implementation as each of the DC motors power up, automatic load sharing correction begins immediately. This is because the minimum threshold value is the error between the A motor field 910 and B motor field, i.e. the difference between the steady state value of the motors with no load applied. Thus, the A motor field out signal 950 from isolator card 900 is used as the bias set point control signal for the B motor field control circuitry. In one embodiment of the isolator card 900 and load share card 990, the A motor shunt 810 and B motor shunt 830 signals are sent to duplicate isolation circuits and the signals are then filtered to reduce noise and carriers. After filtering, the A motor arm signal 930 is input to Pin_9 935 and the B motor arm signal 940 is input to Pin_15 945. In FIG. 9b, the two signals are sent to integrator circuit 855 that determine the error between the signals. Thus, the implementation of the load sharing card to determine the error between power output signal 810 and 830 of the A motor and B motor is identical to FIG. 8. However as shown in FIG. 9a, this implementation differs from FIG. 8 in that the signals A motor field 910 is input into an isolator circuit similar to the isolator circuits described for FIG. 8. The A motor field out signal 950 is input to Pin_19 955 to produce A mtr Trim signal 960 that is used as a variable bias set point which is then fed into operational amplifier 980 allowing immediate automatic load sharing correction as described above.

Turning now to FIG. 10, a schematic diagram of a fan loss card 1000 in accordance with a preferred embodiment of the invention is shown. Preferably, the fan loss card is used to monitor the current draw of the cooling fans that move air across the SCR heat sinks. Too much current draw from a motor turning the cooling fan denotes a defective or failing cooling fan motor. In the preferred embodiment, fuse F1 1010 opens if the current that flows through it becomes excessive. The current to power the cooling fans enters fan loss card 1000 at connector JA-1 1005 and goes through fuse Fl 1010. Transformer T1 1015 preferably receives the current after it has traveled through fuse F1 1010 and outputs the transformed current to the fan motors (not shown). Preferably, transformer T1 secondary current that is proportional to the fan motor current is amplified and rectified to create a driving signal through transistor Q1 1025. In the preferred embodiment, the output signal from transistor Q1 is fed into relay K1 1030. The contacts of relay K1 1030 are utilized in the SCR control logic circuitry to perform alarm and protection functions.

FIG. 11 shows a detailed schematic diagram of the top drive interface card 1100 in accordance with the preferred embodiment of the invention. Preferably, the top drive interface card 1100 is a rack mounted card capable of slidable insertion into a card slot in a bay. In an alternative embodiment, the top drive interface card 1100 may be bolted into the card rack using fasteners such as screws or bolts. The top drive card interfaces to the other circuitry of the SCR drive system the throttle and speed control mechanisms (e.g. hand levers and foot pedals) used by the drill operator for controlling the DC motors. In addition, in the preferred embodiment the card provides current limit and stall protection (to prevent a DC motor from stalling for a long period resulting in damage to the motor) for each motor. A stall of the motor may occur for example if the drill bit is stuck, thus halting the DC motor that is still being supplied by current from the SCR. Preferably, as shown in FIG. 11, the driller sets the maximum allowable motor torque during stall that the DC motor can safely handle. The current corresponding to maximum allowable motor torque is input onto signal line 1110. The actual motor torque is fed back into the top drive interface card on input signal line 1130 from the DC motor. Preferably, the actual motor torque from the DC motor is continuously compared to the maximum allowable motor torque. Operational amplifier 1140 performs a comparison subtraction operation to determine if the actual motor torque of the DC motor nears or exceeds the maximum allowable motor torque. If the actual motor torque of the DC motor nears or exceeds the maximum allowable motor torque, diode 1145 is forward biased forcing operational amplifier 1155 to hit a rail. Forward biased diode 1145 also allows RC network 1160 to ramp up and after an RC time period frees the motor from driller control and permits the motor to relax. Thus, after the operational amplifier 1155 hits a rail, the RC circuit 1160 begins to ramp up over a finite period of time corresponding to the values of the resistance R and capacitance C. The RC time period is determined based on the maximum time that the DC motor can be stalled without damaging the motor. In the preferred embodiment, after the motor is freed from driller control, the driller must bring the throttle to zero position and reset, otherwise the motor remains latched in the relaxed state. The stall protection system of the preferred embodiment protects the DC motor and provides drilling functionality needed by the drill operator.

Turning now to FIG. 12, a schematic diagram of an analog current isolator card 1200 in accordance with a preferred embodiment of the invention is shown. Preferably, the isolator card allows external hardware circuitry (i.e. third party hardware cards) to connect to the SCR system control circuitry without loading down the SCR circuitry. This is because isolator card 1200 has high impedance front end inputs that isolate the third party hardware load from the SCR circuitry. The current isolator card receives field current shunt input signals at J1 1225 and generates appropriate scaled voltage signals at output port 1220. In the preferred embodiment, the AD202JY chip 1230 provides galvanic isolation between the shunt inputs 1225 and the output signals at 1220. Preferably, the output at 1220 is a signal that can be utilized in any appropriate circuit where isolated and scaled feedback signals in low voltage analog circuitry is required. The analog current isolator card in the preferred embodiment also includes K1 relay 1230 contacts that are available through connector J3 1235 and can be utilized for signal level detection. In the preferred embodiment, the scaled voltage signal at output port 1220 is applied to the positive input of operational amplifier 1240. Preferably in one aspect of the invention, operational amplifier 1240 is used as a high impedance buffer amplifier. The output signal from operational amplifier 1240 is absoluted and applied to the positive terminal of operational amplifier 1250 where it is compared to a setpoint bias input at operational amplifier 1250 negative terminal. When the absoluted signal exceeds the setpoint bias, relay K1 1230 will be energized through transistor Q1 1260.

FIG. 13 shows a preferred embodiment of a schematic diagram for an engine control card 1300. Preferably, the engine control card 1300 is part of the larger generator control module and adjusts the speed of the engine AC generator 110 at idle and run through separate stability adjustments. The engine control card 1300 also limits fuel flow during engine start and idle to reduce airborne pollutants. Finally, in the preferred embodiment the engine control card 1300 is able to shut down the engine AC generator in the event the engine reaches a high rotations-per-minute (“RPM”), i.e. the engine over speeds. In the preferred embodiment, the engine control card 1300 can be in one of the four states of Off, Idle, Run and Run/Load. The engine 110 is off when the control card 1300 is in the Off state, at idle speed when the control card 1300 is in Idle state, and at various operating speeds when the control card 1300 is in Run or Run/Load state. In the preferred embodiment of the engine control card 1300 shown in FIG. 13, Engine On/Off 1370, Engine Run 1342, Engine Idle 1360, KW Signal 1315, KW Load Share 1317, Actuator 1357, Speed FB 1340, and Tach 1367 are input/output signals from other control circuits of the SCR drive system. Engine Idle input line 1360 couples to start and fuel limiting circuitry 1350 including the LM317T component 1330. When the engine AC generator 110 is in an idle state, Engine Idle signal 1360 is in On state and signal Engine Run 1342 is in Off state. The fuel limiting circuitry operates during engine start and idle, that is when the Engine Idle signal 1360 is in the On state. The fuel limiting circuitry includes a LM 317T voltage regulator chip 1330 to provide a low component count method of limiting available voltage and current to the engine fuel control actuator 1357.

FIG. 14 shows one preferred embodiment of the LM 317T used as a 3 pin adjustable voltage regulator. In the embodiment shown, with the input voltage in a range greater than or equal to 28 V, the output voltage becomes:

V_{OUT}=V_{REF}(1+R2/R1)+I_{ADJ}(R₂), V_{REF}=1.25 volts

Capacitors 1410 is normally not needed unless the LM 317T is situated more than six inches from any input filter capacitors in which case bypass capacitor 1410 is needed Similarly optional output capacitor 1420 can be added to the voltage regulator circuit to improve V_{OUT} transient response. In operation, the LM 317T develops a nominal 1.25V reference voltage, V_{REF}, between the output and adjustment terminal. The reference voltage is impressed across program resistor R1 and, since the voltage is constant, a constant current I₁ then flows through the output set resistor R2, giving the output voltage of V_{OUT} given by the equation above.

Returning now to the fuel limiting circuitry 1350 of engine control card 1300 shown in FIG. 13 current to the engine fuel actuator 1357 (actuator not shown, only lines to actuator are shown) can be limited by utilizing a single relay 1358 and potentiometer 1359 in conjunction with the LM 317T 1330. In the Idle state, the potentiometer 1359 is connected via the relay 1358 to the LM 317T 1330. This potentiometer 1359 controls a reduced output voltage to the fuel actuator 1357. This reduced output to the actuator 1357 helps to limit the amount of fuel pumped into the engine cylinders during cranking and engine idle cycles. This cuts down on black smoke and air pollution at engine start and idle. When the engine is in a run state, the LM 317T is set to limit the voltage to the actuator at the maximum allowable by the fuel actuator manufacturer. In the preferred embodiment, the actuator is usually a Woodward model EG3-P. A magnetic pickup on a flywheel in the Engine AC generator produces a signal corresponding to the RPM speed of the engine that is then input to a LM2907N-8 1365 tachometer chip. The tachometer chip 1365 generates a DC output signal that is then filtered, scaled, and amplified by circuitry 1368. If the tachometer signal indicates overspeed, that is the engine reaches a high RPM that may damage the engine, overspeed trip set point circuitry 1380 is able to shut down the engine AC generator. The tachometer signal 1367 after being compared to a speed signal set by potentiometer 1355 is output on Speed FB line 1340 into regulator speed feedback circuitry and summed at summing point 1335. Summing point 1335 adds all signals algebraically to produce an output signal in the direction of resistor/capacitor circuit 1336.

In the preferred embodiment of the engine control card 1300 shown in FIG. 13, LM 317T 1310 is part of the speed regulator circuitry and is used as a stable and adjustable engine speed control chip. As described above, the LM 317T functions well as a speed control chip because its output is a function of the set point components without regard to supply voltage fluctuations and temperature changes. Thus, the speed setpoint of the engine is inherently stable. The output of LM 317T is used to set the desired idle speed through potentiometer 1325 when the Engine AC generator controller is in an idle state. When the Engine AC generator controller changes state from idle to run based on user input, speed reference circuitry 1326 creates a linear ramp that allows the AC generator engine to rev up to run speeds without causing damage to the engine. Once the ramp reaches a plateau to get to the proper run speed, the current at summation 1335 becomes steady state, so changes to the run speed at summation 1335 are strictly a function of the speed feedback circuit 1340.

Finally in the preferred embodiment of the invention, the engine control card 1300 allows load sharing with a plurality of other engine AC generators. Resistive bridge network 1320 compares the Kilowatt (“KW”) signal 1315 of this engine AC generator to the KW load share signal 1317 of all other engine AC generators and creates an error that goes into summation point 1335. Thus, KW load sharing guarantees that all generators will see an equal load to generate equal horsepower allowing many engine AC generators in the SCR drive system to connect.

Turning now to FIG. 15, in accordance with the preferred embodiment of the invention, the schematic diagram of an amplifier and transducer card 1500 is shown. Preferably, this card amplifies the three phase current signals 1510(a)-1510(c), Volts Amps Reactive (“VAR”) signal (1540) and KW signal (1520) and converts these amplified signals through transducer circuitry so that they can each be viewed on a meter. The amplified three phase current signals 1515(a)-1515(c), VAR signal 1550 and KW signal 1525 are also buffered and output to various other cards in the SCR drive system. In the preferred embodiment of the invention, the transducer circuitry shown in FIG. 15 receives Phase A current signal 1510(a) that is then output through Ammeter A line 1515(a) to drive an ammeter (current meter). Similarly, output signals Ammeter B 1515(b) and Ammeter C 1515(c) drive separate current meters to enable a drill operator to view the amperage of Phase B current and Phase C current respectively. Likewise, output signal KW meter 1530 and KVAR meter 1560 also drive appropriate meters that display the power and variance. Variance represents the quantity difference between real (working) power and non-real (reactive) power. Parallel generator circuits compare variance VAR signals to determine generator load share.

In the preferred embodiment of the invention, reverse power trip circuitry (not shown) provides KW reverse power trip 1580 and reset 1590 functions. An SCR drive system may include multiple Engine AC generators 110 that each output AC power onto a common AC bus. In such a multi-engine system, if one engine malfunctions, then the generator may become a synchronous motor and load to the system. The generator now acting as a motor and still attached to the engine may overspeed and destroy the engine. Thus, in order to protect the generator and the engine, reverse power trip circuitry uses bipolar signals to determine if power is being consumed by a generator acting as a motor on the AC bus. In such a scenario, a Revpwr trip input line 1580 receives a trip signal from the reverse power trip circuitry that trips a circuit breaker 1570 and take the faulty Engine AC generator off the line. Once the engine AC generator is removed from the SCR drive system or repaired and no power is consumed on the AC bus, the reverse power trip circuitry asserts the Revpwr reset signal 1590 that resets the circuit breakers 1570.

FIG. 16 shows a schematic diagram for a generator voltage regulator card 1600 in accordance with one preferred embodiment of the invention. The generator voltage regulator card 1600 receives an input voltage signal at AC Input 1 1603 and AC Input 2 1604. Preferably, AC Input 1 1603 represents the magnitude and AC Input 2 1604 represents the frequency of the voltage generated by a three phase AC generator. In the preferred embodiment, PWM control 1640 outputs an error signal derived from the error between a setpoint value created by user adjustable potentiometer R27 1650 and the input signals AC Input 1 1603 and AC Input 2 1604. Preferably, generator voltage regulator card 1600 also receives KVAR signal 1610 and KVAR load share signal 1620 that allows KVAR load-sharing between 2 or more Engine AC generators coupled on a common AC bus. Signal Load 1605 functions as a control input for relay K1 1607. Thus, if Load 1605 is tied to ground, relay K1 1607 is energized and the KVAR load sharing describe above is activated. Otherwise, if relay K1 is not energized (i.e. Load 1605 not tied to ground) the circuitry will maintain near zero KVAR.

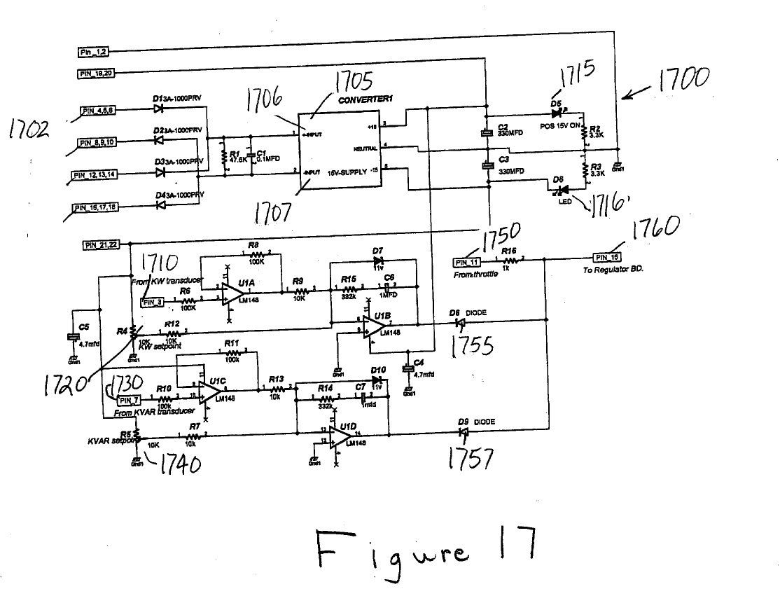

Turning now to FIG. 17, in accordance with the preferred embodiment of the invention, the schematic diagram of a power supply card 1700 is shown. Preferably, the power supply card powers the control circuitry of the SCR drive system using a battery, wall outlet power source or any other input power source. Diode steering allows dual AC-to-DC transformed 24 volt DC power sources to be connected simultaneously with one source connected across terminal 1702(a) and 1702(b) and another DC source connected across terminal 1703(a) and 1703(b). Converter 1705 receives an AC-to-DC transformed +24 volt DC voltage signal at its +input 1706 and −24 volts at its −input 1707 that is converted to +/−15 volt supply signals for use in powering the SCR drive system control cards. When Light Emitting Diode (“LED”) 1715 is lighted, this indicates that the converter is producing +15 volts and similarly lighted LED 1716 indicates that the converter 1705 is producing −15 volts. Input signals corresponding to power acknowledge OK from KW transducer 1710, KW setpoint 1720, KVAR transducer 1730, KVAR setpoint 1740 and throttle request signal 1750 directly from the operator controller inform the power supply card 1700 that the control cards corresponding to these signals are functioning properly. Output signal 1760 is the throttle signal that is output to the generator voltage regulator board 1600. Throttle signal 1760 is clamped by the action of diode D8 1755 and diode D9 1757 to prevent the KW or KVAR signal from overloading the engine AC generator.

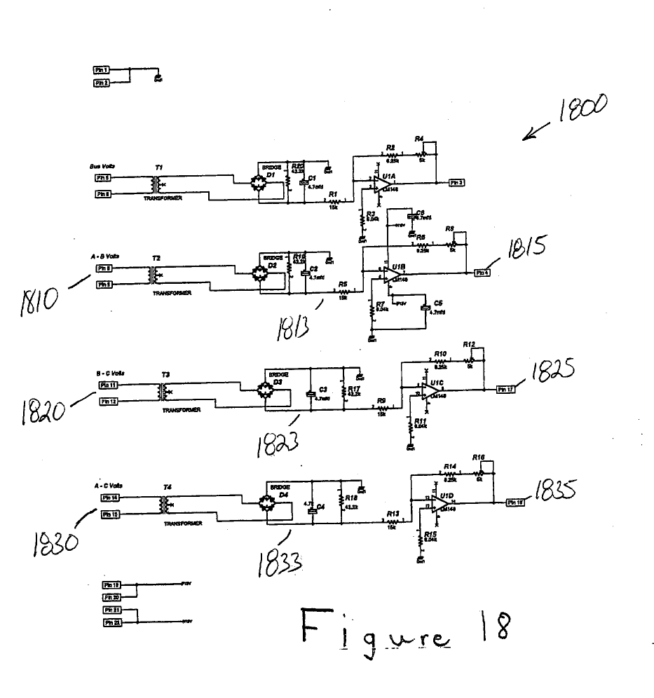

FIG. 18 shows a schematic diagram for a voltmeter scaling and display card 1800 in accordance with one preferred embodiment of the invention. Preferably, voltmeter scaling card 1800 receives as inputs, signals representing the three phase 600 V AC system voltage at inputs 1810 (Phase A-B), 1820 (Phase B-C), and 1830 (Phase AC). Conversion circuitry 1813, 1823, and 1833 corresponding respectively to the phases above generates low voltage DC equivalent voltages at output terminals 1815, 1825, and 1835 capable of supplying power to operate a panel mounted voltmeter display.

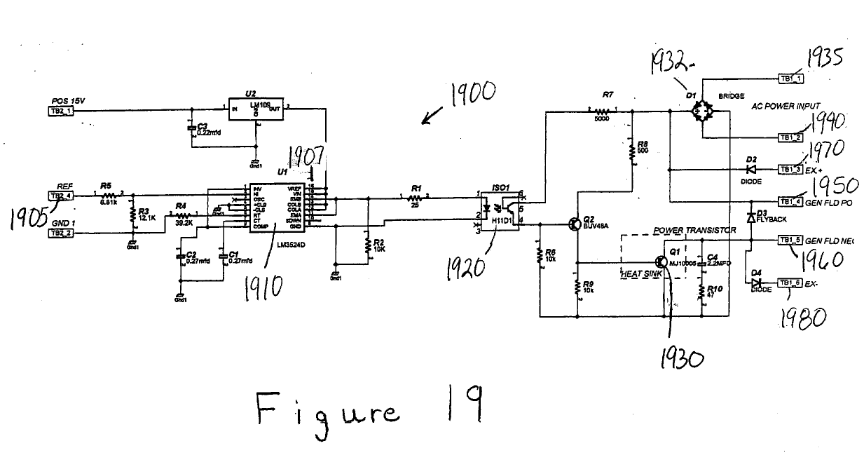

Turning now to FIG. 19, in accordance with the preferred embodiment of the invention, the schematic diagram of an AC generator field exciter power board 1900 is shown. Preferably, the field exciter power board provides the excitation current required to excite the main AC generators. The AC generator excitation current is the current that flows in any winding used to excite the generator when all other windings are open-circuited. Excitation current to excite the main AC generators is needed to establish a desired voltage and to maintain the desired voltage under all load conditions. In the preferred embodiment, excitation current from a DC source is received at inputs EX+ 1970 and EX− 1980 and can be used to manually excite the AC generator 110. Field exciter power board 1900 receives the PWM control signal 1640 from generator voltage regulator card 1600 at signal line REF 1905. This input voltage is sent to LM 3524D Pulse-Width-Modulation (“PWM”) chip 1910 that then outputs a square wave voltage signal with a duty cycle proportional to the zero to five volt signal at the PWM chip 1910 control input VREF 1907. Optoisolator 1920 serves to galvanically isolate the PWM chip that operates at a maximum of 5 volts DC, from the high voltage circuitry following optoisloator 1920. The output isolated voltage from the optoisolator 1920 drives power transistor 1930. Transistor 1930 in the preferred embodiment is a switch, which turns on with the “on cycle” of the PWM square wave, and turns off with the “off cycle” of the PWM square wave. The transistor 1930 is connected in series to the GEN FLD POS 1950 and GEN FLD NEG 1960 outputs which can have DC voltage values ranging between the positive and negative DC voltage produced by diode bridge rectifier 1932. Preferably, the bridge 1932 receives an AC voltage signal at 1935 and 1940 from an appropriate source and rectifies the AC into a DC voltage. In alternative embodiments, the AC voltage supplied to the bridge 1932 can be from any source including a permanent magnet generator which rotates with the main engine generator 110 or from a transformer which transforms the output of the main engine generator 110 to a level usable on the bridge 1932.

Various advantages and benefits may be gained by practicing the invention disclosed. Use of simple analog hardware cards eliminates rig downtime otherwise prevalent in software controlled digital systems. The analog control SCR drive system described above is not prone to software bugs that can “crash” the drilling system and cause expensive downtime. If an analog hardware card becomes faulty, the drill operator can replace the card to bring the system back up without having to call a field technician or engineer.

The above discussion is meant to be illustrative of the principles and various embodiments of the present invention. Numerous variations and modifications will become apparent to those skilled in the art once the above disclosure is fully appreciated. For example, even though in the preferred embodiment the hardware is used to control motors for mud pumps and other drill mechanisms for oilfield drilling the same control hardware could be used to drive motors used in machinery for dredging, marine propulsion, and mining.

### REFERENCES

The following references, to the extent that they provide exemplary procedural or other details supplementary to those set forth herein, are specifically incorporated herein by reference.

1. National Semiconductor LM117/LM317A/LM317 3-Terminal Adjustable Regulator, www.national.com, May 2001

What is claimed is:

1. A silicon controlled rectifier (SCR) system for drilling a borehole, said SCR system including modular analog hardware comprising:
a SCR that converts alternating current (AC) to direct current (DC);
an engine AC generator for generating alternating current coupled to said SCR;
an AC generator controller coupled to the engine AC generator;
one or more DC motors coupled to the SCR;
a DC load coupled to said one or more DC motors through mechanical means;
a DC load controller coupled to the SCR and DC motors, wherein said DC load controller further comprises:
isolator hardware that receives a first signal and a second signal, said isolator hardware filtering the first signal and the second signal to reduce noise and carriers;
load share hardware coupled to the isolator hardware, wherein said load share hardware receives the filtered first signal and second signal and determines the error between the two signals;
feedback hardware coupled to the load share hardware, said feedback hardware modifying a power output of one motor based on the error; and
wherein said DC load controller performs automatic load share control between the DC motors as each DC motor powers up.

2. The SCR system of claim 1 wherein said DC load controller receives control parameters from the SCR and generates control signals to the DC motors.

3. The SCR system of claim 1 wherein said DC motors are shunt wound DC motors.

4. The SCR system of claim 1 wherein said mechanical means is a rotatable shaft.

5. The SCR system of claim 1 wherein said AC generator controller further comprises an engine control module that controls operating speed of the engine AC generator.

6. The SCR system of claim 1 wherein said AC generator controller further comprises an engine control module that controls air-fuel mixture at engine start.

7. The SCR system of claim 1 wherein said DC load is a mud pump.

8. The SCR system of claim 1 wherein said engine of the engine AC generator is a diesel engine.

9. A method for drilling a borehole utilizing a modular analog hardware silicon controlled rectifier (SCR) system, comprising the steps of:
performing an engine start of an engine AC generator using a lean mixture of air and fuel, wherein said engine AC generator is coupled to a engine control module that controls said mixture of air and fuel;
adjusting said engine AC generator using said engine control module to a constant engine speed by performing feedback control; and
drilling a borehole by maintaining constant engine speed that generates sufficient rotation of a drill bit.

10. The method of claim 9 wherein said engine of the engine AC generator is a diesel engine.

11. The method of claim 9, wherein the step of drilling a borehole further comprises the steps of:
transforming alternating current (AC) power generated by the engine AC generator into direct current (DC) power using a silicon controlled rectifier (SCR);
powering one or more DC motors using said SCR transformed DC power, wherein said DC motors operate a drilling mechanism; and
controlling the steps of transforming AC to DC power and powering the DC motors by utilizing a DC load controller coupled to the SCR and DC motors.

12. The method of claim 11, wherein said DC load controller performs automatic load share control between two or more DC motors.

13. The method of claim 12, wherein automatic load share control further comprises the steps of:
receiving a first signal and a second signal in isolator hardware, said isolator hardware filtering the first signal and the second signal to reduce noise and carriers;
determining the error between the two signals, said determining occurring in load share hardware coupled to the isolator hardware, wherein said load share hardware receives the filtered first signal and second signal; and
modifying a power output of one motor based on the error, said modifying occurring in feedback hardware coupled to the load share hardware.

14. A hardwired control system of modular design for drilling a borehole, comprising:
a silicon controlled rectifier that converts alternating current (AC) to direct current (DC);
a diesel engine AC generator for generating alternating current coupled to said SCR;
an AC generator controller coupled to the diesel engine AC generator, wherein said AC generator controller includes an engine control module that controls operating speed of the diesel engine AC generator and air-fuel mixture at diesel engine start;
one or more DC motors coupled to said silicon controlled rectifier; and
a DC load controller coupled to said silicon controlled rectifier and said DC motors, said DC load controller receiving control parameters from the silicon controlled rectifier and DC motors and generating control signals to the silicon controlled rectifier and DC motors.

15. The hardwired control system of claim 14 wherein said hardwire control system includes analog circuitry.

16. A hardwired control system of modular design for drilling a borehole, comprising:
a transformer that converts alternating current (AC) to direct current (DC);
a diesel engine AC generator for generating alternating current coupled to said transformer;
an AC generator controller coupled to the diesel engine AC generator;
a DC load coupled to said transformer, wherein said DC load is an electric motor; and
a DC load controller coupled to said transformer and DC load, said DC load controller receiving control parameters from the transformer and DC load and outputting control signals to the transformer and DC load.

17. The hardwired control system of claim 16 wherein said AC generator controller includes an engine control module that controls operating speed of the diesel engine AC generator and air-fuel mixture at diesel engine start.

18. The hardwired control system of claim 17 wherein the transformer is a silicon controlled rectifier (SCR).

19. The hardwired control system of claim 16 wherein said hardwire control system includes analog circuitry.
